(19) United States
(12) Patent Application Publication
(10) Pub. No.: US 2026/0359943 A1
(43) Pub. Date: Nov. 12, 2026

(54) IMAGE PROCESSING METHOD AND APPARATUS, DEVICE, AND MEDIUM

(71) Applicant: Beijing Zitiao Network Technology Co., Ltd., Beijing (CN)

(72) Inventors: Qin XU, Beijing (CN); Ziyang CHENG, Beijing (CN)

(21) Appl. No.: 19/491,600

(22) PCT Filed: Jun. 25, 2024
(86) PCT No.: PCT/CN2024/101169

§ 371 Date: Dec. 9, 2025

(30) Foreign Application Priority Data
Jun. 26, 2023 (CN) 202310762692.2

(51) Int. Cl. G06T 5/60; G06T 5/50; G06T 5/77; G06T 7/11; G06V 10/25; G06V 10/74; G06V 10/75; G06V 10/776; G06V 10/82

(52) U.S. Cl. CPC G06T 5/60; G06T 5/50; G06T 5/77; G06T 7/11; G06V 10/25; G06V 10/759; G06V 10/761; G06V 10/776; G06V 10/82; G06T 2207/20084

(57) ABSTRACT

Embodiments of the present disclosure relate to an image processing method and apparatus, a device, and a medium. The method includes: obtaining a first image to be processed; detecting a target region in the first image, and masking the detected target region to obtain a second image; and performing retouching based on the second image to obtain a target image, where there is a difference between a target region in the target image and the target region in the first image.

### CROSS-REFERENCE TO RELATED APPLICATION(S)

The present application claims priority to Chinese Patent Application No. 202310762692.2, filed on Jun. 26, 2023 and entitled “IMAGE PROCESSING METHOD AND APPARATUS, DEVICE, AND MEDIUM”, which is incorporated herein by reference in its entirety.

### FIELD

The present disclosure relates to the field of image processing technologies, and in particular, to an image processing method and apparatus, a device, and a medium.

### BACKGROUND

An image retouching function has been widely used in many application occasions such as image editing software, photographing software, and a live streaming platform. A user may adjust an image according to requirements, such as beautifying a face image. However, the inventor has found through research that the existing image retouching function is mainly to automatically retouch an image for the whole face or the whole body, or the user needs to spend time and effort on manual image retouching, making it difficult to meet the requirements of part of users to conveniently adjust a local area in an image.

### SUMMARY

To solve the abovementioned technical problems or at least partially solve the abovementioned technical problems, the present disclosure provides an image processing method and apparatus, a device, and a medium.

An embodiment of the present disclosure provides an image processing method. The method includes: obtaining a first image to be processed; detecting a target region in the first image, and masking the detected target region to obtain a second image; and performing retouching based on the second image to obtain a target image, where there is a difference between a target region in the target image and the target region in the first image.

Optionally, the performing retouching based on the second image to obtain a target image includes: detecting a specified sub-region in the target region in the first image to obtain a sub-region detection result; and performing retouching based on the sub-region detection result and the second image to obtain the target image.

Optionally, a specified sub-region in the target image matches the specified sub-region in the first image.

Optionally, the sub-region detection result is presented in the form of a lower tooth area mask image, and the performing retouching based on the sub-region detection result and the second image includes: inputting the specified sub-region mask image and the second image into a preset neural network model, so that the neural network model retouches a target region in the second image based on the sub-region detection result.

Optionally, the neural network model is obtained through the following steps: obtaining a first sample image; detecting a target region in the first sample image, and masking the detected target region to obtain a second sample image; obtaining a specified sub-region mask image corresponding to the first sample image, and inputting the second sample image and the specified sub-region mask image into an initial neural network model to obtain a generated image output by the initial neural network model; and adjusting parameters of the initial neural network model based on the generated image, the first sample image and a preset loss function until a neural network model meeting a preset condition is obtained.

Optionally, a degree of beauty of the target region in the first sample image is greater than a preset degree threshold.

Optionally, the adjusting parameters of the initial neural network model based on the generated image, the first sample image and a preset loss function includes: obtaining an adversarial loss value between the generated image and the first sample image based on a preset adversarial loss function; obtaining a pixel loss value between the generated image and the first sample image based on a preset pixel loss function; and adjusting the parameters of the initial neural network model based on the adversarial loss value and the pixel loss value.

Optionally, the masking the detected target region to obtain a second image includes: generating a target region mask image based on the detected target region; and generating the second image based on the target region mask image and the first image, where pixel values of a target region in the second image are all specified pixel values.

An embodiment of the present disclosure further provides an image processing apparatus. The apparatus includes: an image obtaining module configured to obtain a first image to be processed; an area masking module configured to detect a target region in the first image, and mask the detected target region to obtain a second image; and an image retouching module configured to perform retouching based on the second image to obtain a target image, where there is a difference between a target region in the target image and the target region in the first image.

An embodiment of the present disclosure further provides an electronic device. The electronic device includes: a processor; and a memory configured to store instructions executable by the processor, where the processor is configured to read the executable instructions from the memory, and execute the instructions to implement the image processing method according to the embodiment of the present disclosure.

An embodiment of the present disclosure further provides a computer-readable storage medium having a computer program stored thereon, where the computer program is configured to perform the image processing method according to the embodiment of the present disclosure.

The abovementioned technical solutions provided in the embodiments of the present disclosure can detect the target region in the first image to be processed, mask the detected target region to obtain the second image, and further perform retouching based on the second image to obtain the target image, where there is a difference between the target region in the target image and the target region in the first image.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a schematic flowchart of an image processing method according to an embodiment of the present disclosure;

FIG. 2 is a schematic diagram of model obtaining according to an embodiment of the present disclosure;

FIG. 3 is a flowchart of an image processing method according to an embodiment of the present disclosure;

FIG. 4 is a comparison diagram of an effect of an image processing method according to an embodiment of the present disclosure;

FIG. 5 is a schematic structural diagram of an image processing apparatus according to an embodiment of the present disclosure; and

FIG. 6 is a schematic structural diagram of an electronic device according to an embodiment of the present disclosure.

### DETAILED DESCRIPTION OF EMBODIMENTS

For a clearer understanding of the abovementioned objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all the embodiments of the present disclosure.

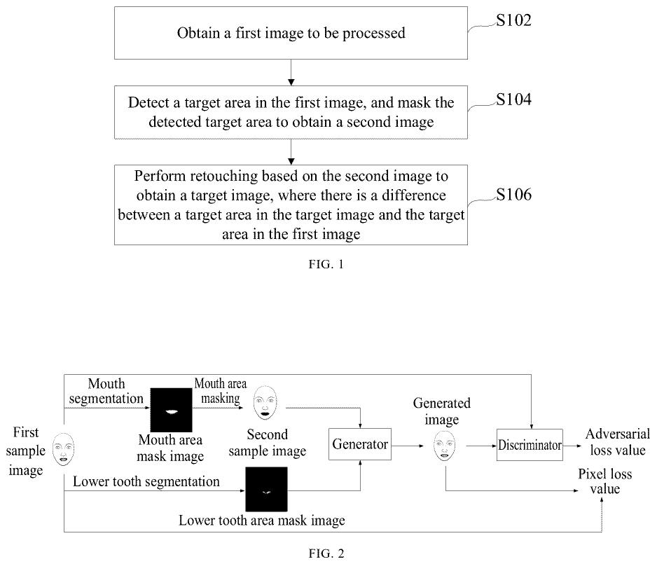

FIG. 1 is a schematic flowchart of an image processing method according to an embodiment of the present disclosure. The method may be performed by an image processing apparatus, which may be implemented using software and/or hardware and may generally be integrated into an electronic device. As shown in FIG. 1, the method mainly includes the following steps S102 to S106.

Step S102: A first image to be processed is obtained. For example, the first image is an image containing a target region. The target region may be, for example, a local area of a target object. The target object may be, for example, a human, a cat, or a specific item. The local area of the target object may be, for example, a body part of a person or an animal, such as a tooth, an eye, or an arm, and may also be a wheel of a vehicle, a trunk of a tree, etc. The embodiment of the present disclosure does not limit the target object and the local area of the target object herein, which may be flexibly set according to requirements. In addition, the embodiment of the present disclosure does not limit the manner of obtaining the first image. For example, the first image may be an image photographed and uploaded by a user, an image selected by the user from local storage, an image downloaded by the user over a network, or an image transmitted from another device.

Step S104: A target region in the first image is detected, and the detected target region is masked to obtain a second image.

In practical applications, an existing target detection model may be used to detect the target region. A detection principle includes, but is not limited to, detecting a plurality of key points to determine the target region. Taking the target region being a mouth area of the target object as an example, the mouth area may be determined by detecting a plurality of mouth key points. In order to facilitate processing of the target region, in the embodiment of the present disclosure, the target region is directly masked (which may also be referred to as occluded). The embodiment of the present disclosure does not limit the manner of masking. For example, pixel values in the target region may be uniformly changed to preset special pixel values, such as setting RGB pixel values to (0, 0, 0), that is, enabling the entire target region to appear black.

Step S106: A target image is obtained by performing retouching based on the second image, where there is a difference between a target region in the target image and the target region in the first image.

The embodiment of the present disclosure does not limit the manner of retouching. For example, a masked target region in the second image may be filled based on an image retouching technology. Taking the target region being the mouth area as an example, the masked mouth area in the second image may be filled with teeth based on the image retouching technology. In a specific implementation, a neural network model (which may also be referred to as an area adjustment model) provided in the present application may be used to directly process the second image. The target region in the obtained target image is generated by the neural network model through filling, and has a certain difference from the original target region of the target object in the first image. For example, the neural network model can generate a more beautiful target region, thereby achieving beautification of the target region. That is, a degree of beauty of the target region in the target image is higher than that of the target region in the first image. Taking the target region being the mouth area of the target object as an example, by adopting the abovementioned manner, a more beautiful mouth area can be generated by using the neural network model through filling. Specifically, the neural network model has the ability to generate beautiful teeth through filling. That is, the degree of beauty of the teeth of the target object in the target image is higher than that of the teeth of the target object in the first image, such that the mouth of the target object has a better visual appearance on the whole.

That is, by adopting the abovementioned manner, the target region in the first image can be optimally adjusted. Certainly, optimal adjustment of the target region is only an example. In practical applications, the target region may also be adjusted according to requirements, such as being adjusted to a target region having a specific appearance. For ease of understanding, taking the target region being the mouth as an example, adjustment is not limited to optimal adjustment of the teeth in the mouth, and may further include adjusting the teeth in the mouth to effects fangs or the like, which is not limited herein. This mainly depends on the characteristics or the model training manner of the neural network model, and may be specifically and flexibly set.

By adopting the abovementioned manner of first masking and then retouching the target region, the target region in the image can be conveniently and effectively adjusted, thereby better meeting user requirements.

The embodiment of the present disclosure first provides a manner of masking the detected target region to obtain the second image, which may be performed with reference to the following step (1) and step (2).

Step (1): A target region mask image is generated based on the detected target region. In practical applications, first, the detected target region may be segmented to generate the target region mask image. The target region mask image may be a binary image composed of pixel values 0 and 1. The target region and a non-target region in the first image may be clearly identified through the target region mask image, and pixel values of the target region and the non-target region are different.

Step (2): The second image is generated based on the target region mask image and the first image, where pixel values of a target region in the second image are all specified pixel values, and pixel values of a non-target region in the second image are consistent with the pixel values of the non-target region in the first image. In practical applications, the target region and the non-target region in the first image may be clearly determined based on the target region mask image, and the pixel values of the target region in the second image are uniformly set to specified pixel values, such as RGB pixel values (0, 0, 0) corresponding to black. Whereas the pixel values of the non-target region in the second image are still equal to the pixel values of the non-target region in the first image, that is, the pixel values of the non-target region remain unchanged. By adopting the abovementioned manner, the second image in which the target region is masked can be efficiently and reliably obtained.

In order to more accurately perform retouching to obtain a target image that better meets user requirements, an embodiment of the present disclosure provides a specific implementation example of performing retouching based on the second image to obtain the target image, which may be performed with reference to the following step A and step B.

Step A: Detect a specified sub-region in the target region in the first image to obtain a sub-region detection result. The specified sub-region may be flexibly set according to requirements, usually depending on the type of the target region. For example, if the target region is the mouth area, the specified sub-region may be a lower tooth area in the mouth area; for another example, if the target region is an eye area, the specified sub-region may be a pupil area; and for another example, if the target region is a tree trunk area, the specified sub-region may be a tree hole area. In practical applications, it is possible to use a target detection algorithm to detect the specified sub-region. Specifically, it is also possible to use a corresponding detection algorithm to perform detection based on the type of the specified sub-region. For example, if the specified sub-region is the lower tooth area, a lower tooth detection algorithm is used to detect the lower tooth area. For example, lower tooth key points may be detected to determine the lower tooth area, or a lower tooth segmentation model may be used to detect and segment the lower tooth area.

It should be noted that the specified sub-region may or may not be presented in the target region. Therefore, the sub-region detection result may indicate whether the specified sub-region is presented in the target region. For ease of understanding, taking the target object being a person and the target region being a mouth area of the person as an example, when opening the mouth, the person may expose upper and lower teeth, or may expose only the upper teeth and not the lower teeth. Therefore, a lower tooth detection result obtained by detecting the lower tooth area of the target object in the first image may indicate that the lower teeth of the target object are displayed in the first image, or may indicate that the lower teeth of the target object are not displayed in the first image. That is, the lower teeth of the target object are not detected.

Step B: The target image is obtained by performing retouching based on the sub-region detection result and the second image.

The sub-region detection result may be used to constrain the retouching process of the second image, thereby avoiding the occurrence of a situation where the specified sub-region is presented in the first image but is not generated in the retouching process, or avoiding the occurrence of a situation where the specified sub-region is not presented in the first image but is additionally generated in the retouching process. By detecting the specified sub-region in the first image in advance and referring the sub-region detection result in the retouching process, the specified sub-region in the obtained target image matches the specified sub-region in the first image. For example, the meaning of matching may represent that the specified sub-regions in the two images coincide or differ by less than a preset difference threshold. When the first image contains the specified sub-region, the target image also contains the specified sub-region. When the first image does not contain the specified sub-region, the target image does not contain the specified sub-region, either. By adopting the abovementioned manner, the structure of the target region can match the structure of the target region in the first image, thereby effectively guaranteeing the degree of match between the target region in the target image and the target region in the first image, and guaranteeing the visual experience of the user. For example, taking the specified sub-region being the lower tooth area as an example, it is possible to effectively guarantee that a tooth structure in the target image matches a tooth structure in the first image, thereby avoiding the occurrence of a situation where the lower teeth are presented in the first image but are not generated in the retouching process, or avoiding the occurrence of a situation where the lower teeth are not presented in the first image but are additionally generated in the retouching process, to guarantee that the image has a high degree of tooth match before and after retouching.

In some implementations, the sub-region detection result is presented in the form of a specified sub-region mask image. On this basis, step B may be specifically implemented by inputting the specified sub-region mask image and the second image into a preset neural network model, so that the neural network model retouches the target region in the second image based on the sub-region detection result. The embodiment of the present disclosure does not limit the structure of the neural network model. For example, the neural network model may include a generative adversarial network, which may specifically be a generator. In practical applications, the neural network model may determine a specified sub-region in the masked target region in the second image based on the specified sub-region mask image, and retouch the masked target region in the second image. Specifically, the target region may be filled with respect to a content type of the target region and a content type of the specified sub-region, and the specified sub-region in a filling result matches the sub-region detection result. For example, taking the target region being the mouth area and the specified sub-region being the lower tooth area as an example, upper teeth in the masked mouth area may be generated, and when the specified sub-region mask image indicates that the lower teeth are presented, the neural network model may also generate lower teeth in the masked mouth area, thereby obtaining the target image.

An embodiment of the present disclosure further provides a manner of obtaining the abovementioned preset neural network model, which may specifically be performed with reference to the following step a to step d.

Step a: A first sample image is obtained.

The first sample image is an image containing a target region. Taking the target region being a mouth area of a target object as an example, the target object in the first sample image may be a mouth-opening object, such that teeth of the target object can be clearly exposed. It should be noted that the target object in the first sample image and the target object in the first image may be considered as the same type of objects, such as both being humans, and should not be considered as the same individual. That is, these images are not necessarily images of the same person. In practical applications, there are usually a plurality of first sample images. For example, the plurality of first sample images may be respective toothy smiling images of a plurality of persons.

In some implementation examples, the degree of beauty of the target region in the first sample image is greater than a preset degree threshold. That is, the first sample image is a sample image in which the target region has a higher degree of beauty, such that a neural network model obtained by training using the first sample image can also generate an image with a beautiful target region, thereby achieving optimal adjustment of the target region.

Step b: The target region is detected in the first sample image, and the detected target region is masked to obtain a second sample image. For the specific manners of detecting the target region and masking the target region, reference may be made to the foregoing relevant content, and details are not described herein again.

Step c: A specified sub-region mask image corresponding to the first sample image is obtained, and the second sample image and the specified sub-region mask image corresponding to the first sample image are input into an initial neural network model to obtain a generated image output by the initial neural network model. For the manner of obtaining the specified sub-region mask image corresponding to the first sample image, reference may be made to the foregoing relevant content, and details are not described herein again. It should be noted that the initial neural network model mentioned herein and the preset neural network model previously used for processing the second image have the same structure and different network parameters. By constantly adjusting parameters of the initial neural network model, the foregoing preset neural network model can be finally obtained. The initial neural network model can generate a specified sub-region in a masked target region in the second sample image under the constraint of the specified sub-region mask image corresponding to the first sample image, thereby obtaining the generated image.

Step d: The parameters of the initial neural network model are adjusted based on the generated image, the first sample image and a preset loss function until a neural network model meeting a preset condition is obtained.

It can be understood that if the neural network model has poor parameters, the output generated image does not meet requirements. Therefore, the parameters of the neural network model need to be further adjusted to optimize the target region generation effect of the neural network model. Specifically, the preset loss function may be used to measure a difference between the generated image and the first sample image, such that the parameters of the initial neural network model are inversely adjusted with the goal of reducing the difference until the preset condition is met. The preset condition includes, but is not limited to, the difference (which may be represented by a target loss value) between the generated image and the first sample image being less than a preset threshold or reaching a preset convergence condition, etc. Generally, the neural network model reaching the preset condition can output a generated image that meets requirements.

For example, the preset loss function includes an adversarial loss function and/or a pixel loss function. In some specific implementation examples, step d may be performed with reference to the following step d1 to step d3.

Step d1: An adversarial loss value is obtained between the generated image and the first sample image based on the preset adversarial loss function. In practical applications, the generated image and the first sample image may be input into a discriminator. By outputting the adversarial loss value between the generated image and the first sample image through the discriminator, the realism of the generated image can be measured. The discriminator is mainly configured to discriminate whether the generated image and the first sample image are real or fake. For example, if the discriminator can clearly identify that the generated image is a generated fake image, and the first sample image is a real image, it indicates that the realism of the generated image is poor, and in this case, the adversarial loss value is also high; and if the discriminator considers that the generated image is a real image, it indicates that the realism of the generated image is high. In other words, the generated image output by the neural network model is so realistic that the discriminator confuses the generated image into a real image, and in this case, the adversarial loss value is low.

Step d2: A pixel loss value between the generated image and the first sample image is obtained based on a preset pixel loss function. The pixel loss function is mainly used to measure a pixel difference between the generated image and the first sample image. The smaller the pixel difference is, the more similar the generated image is to the first sample image.

Step d3: The parameters of the initial neural network model are adjusted based on the adversarial loss value and the pixel loss value.

In practical applications, a weight corresponding to the adversarial loss value and a weight corresponding to the pixel loss value may be obtained. The adversarial loss value and the pixel loss value are weighted based on their respective weights to obtain a target loss value (i.e., a total loss value), such that the parameters of the initial network model are adjusted based on the target loss value. The parameters of the initial neural network model are adjusted in a direction of reducing the target loss value until the target loss value converges to less than a preset threshold. In this case, the neural network model is capable of outputting a generated image that is similar to the first sample image and has a relatively strong sense of realism. If the target region of the target object in the first sample image has a higher degree of beauty, the neural network model can also generate an image containing a more beautiful target region, which may be applied to subsequent target region beautification scenarios.

For ease of understanding, taking the target region being the mouth area and the specified sub-region in the target region being the lower tooth area as an example, reference may be made to a schematic diagram of model obtaining shown in FIG. 2, which illustrates that mouth segmentation and lower tooth segmentation are separately performed on the first sample image to obtain a mouth area mask image (corresponding to the foregoing target region mask image) and a lower tooth area mask image (corresponding to the foregoing specified sub-region mask image). Further, mouth area masking is performed based on the mouth area mask image to generate the second sample image. Then, the lower tooth area mask image and the second sample image may be input into a generator, and the generator outputs a generated image. Subsequently, the output image and the first sample image are simultaneously input into the discriminator to obtain the adversarial loss value through the discriminator, and to obtain the pixel loss value based on the generated image and the first sample image. Subsequently, the total loss value may be obtained by weighting the adversarial loss value and the pixel loss value, and parameters of the generator may be adjusted based on the total loss value until a generator with the total loss value meeting a preset condition is obtained. The generator may be used as the foregoing preset neural network model capable of directly retouching the mouth area. The abovementioned process of obtaining the preset neural network model may also be referred to as a model training process.

By adopting the abovementioned model training manner, there is no need to obtain a large number of paired sample images in advance. Specifically, there is no need to obtain images of teeth to be retouched, such as images of irregular teeth, and images of retouched teeth, such as images of regular teeth, in pairs, thereby greatly saving the cost of obtaining the sample images. It can be understood that the number of the existing paired sample images is small, and the difficulty of obtaining is usually high. If the paired sample images are obtained by manual image retouching, the required labor cost is higher. In contrast, by adopting the abovementioned model obtaining manner (which may also be referred to as the model training manner) according to the embodiment of the present disclosure, there is no need to initially obtain the sample images of the teeth to be retouched and the sample images of the retouched teeth in pairs for model training. Instead, mouth area detection and lower tooth area detection are first directly performed on the first sample image with a high tooth degree of beauty, the detected mouth area is masked, a tooth structure in the generated image of the model is constrained to match a tooth structure in the first sample image by using a lower tooth area detection result, and finally the tooth degree of beauty and realistic degree of the generated image of the model can be effectively guaranteed based on an adversarial loss and a pixel loss.

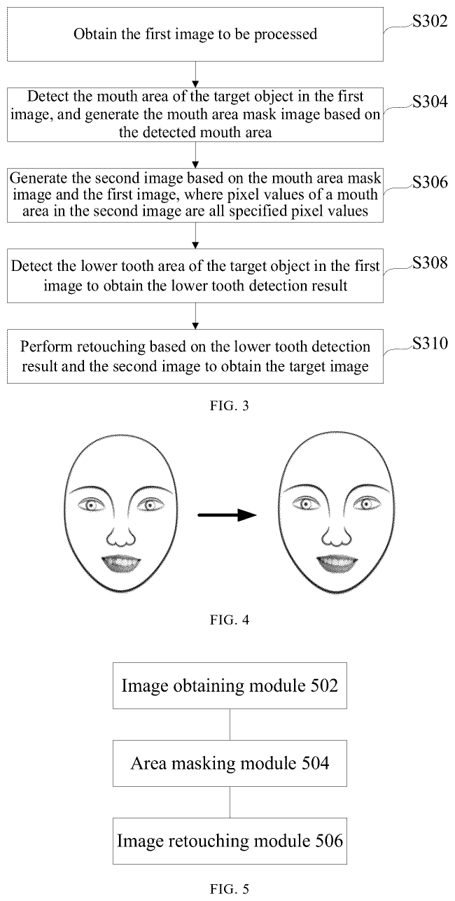

For ease of understanding, on the basis of FIG. 2, further reference may be made to a flowchart of an image processing method shown in FIG. 3, which mainly includes the following steps.

Step S302: The first image to be processed is obtained.

Step S304: The mouth area of the target object in the first image is detected, and the mouth area mask image is generated based on the detected mouth area.

Step S306: The second image is generated based on the mouth area mask image and the first image, where pixel values of a mouth area in the second image are all specified pixel values.

Step S308: The lower tooth area of the target object in the first image is detected to obtain the lower tooth detection result.

Step S310: The target image is obtained by performing retouching based on the lower tooth detection result and the second image.

By adopting the abovementioned manner of first masking and then retouching the mouth area, teeth of the target object in the image can be conveniently and effectively adjusted, thereby better meeting user requirements. Moreover, a tooth structure in the finally obtained target image matches a tooth structure in the first image due to the constraint of the lower tooth detection result in the retouching process, thereby avoiding the occurrence of a situation where lower teeth are not presented in the first image but are presented in the target image, or the lower teeth are presented in the first image but are not presented in the target image to effectively guarantee the reliability of the finally generated target image and comprehensively guarantee the user experience. For ease of understanding, an embodiment of the present disclosure further provides a schematic diagram of an effect of retouching the mouth area through the abovementioned image processing method. As shown in FIG. 4, which illustrates that irregular teeth may be adjusted to regular teeth, which has a better tooth beautification effect and effectively improves the user appearance.

It should be noted that FIG. 2 to FIG. 4 are all illustrated by taking the target region being the mouth area and the specified sub-region in the target region being the lower tooth area as an example. In practical applications, the target region and the specified sub-region thereof may also be, for example, a tree trunk and a tree hole thereof, a flower and a stamen and pistil thereof, or an eye and a pupil thereof, which may be specifically and flexibly set and is not limited herein. By adopting the abovementioned manner provided in the embodiment of the present disclosure, the target region in the image can be conveniently and effectively adjusted, thereby better meeting user requirements.

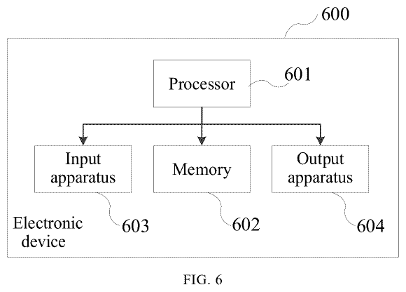

Corresponding to the foregoing image processing method, FIG. 5 is a schematic structural diagram of an image processing apparatus according to an embodiment of the present disclosure. The apparatus may be implemented through software and/or hardware and may generally be integrated into an electronic device. As shown in FIG. 5, the image processing apparatus includes:
an image obtaining module 502 configured to obtain a first image to be processed;
an area masking module 504 configured to detect a target region in the first image, and mask the detected mouth area to obtain a second image; and
an image retouching module 506 configured to perform retouching based on the second image to obtain a target image, where there is a difference between a target region in the target image and the target region in the first image.

The abovementioned technical solution provided in the embodiment of the present disclosure can detect the target region in the first image to be processed, mask the detected mouth area to obtain the second image, and further perform retouching based on the second image to obtain the target image, where there is a difference between the target region in the target image and the target region in the first image. By adopting the abovementioned manner of first masking and then retouching the target region, the target region in the image can be conveniently and effectively adjusted, thereby better meeting the requirement of the user for adjusting the target region in the image.

In some implementations, the image retouching module 506 is specifically configured to: detect a specified sub-region in the target region in the first image to obtain a sub-region detection result; and perform retouching based on the sub-region detection result and the second image to obtain the target image.

In some implementations, a specified sub-region in the target image matches the specified sub-region in the first image.

In some implementations, the sub-region detection result is presented in the form of a specified sub-region mask image; and the area retouching module 506 is specifically configured to: input the specified sub-region mask image and the second image into a preset neural network model, so that the neural network model retouches a target region in the second image based on the sub-region detection result.

In some implementations, the image processing apparatus further includes a model obtaining module configured to obtain the neural network model through the following steps: obtain a first sample image; detect a target region in the first sample image, and mask the detected target region to obtain a second sample image; obtain a specified sub-region mask image corresponding to the first sample image, and input the second sample image and the specified sub-region mask image corresponding to the first sample image into an initial neural network model to obtain a generated image output by the initial neural network model; and adjust parameters of the initial neural network model based on the generated image, the first sample image and a preset loss function until a neural network model meeting a preset condition is obtained.

In some implementations, a degree of beauty of the target region in the first sample image is greater than a preset degree threshold.

In some implementations, the model obtaining module is further configured to: obtain an adversarial loss value between the generated image and the first sample image based on a preset adversarial loss function; obtain a pixel loss value between the generated image and the first sample image based on a preset pixel loss function; and adjust the parameters of the initial neural network model based on the adversarial loss value and the pixel loss value.

In some implementations, the area masking module 504 is specifically configured to: generate a target region mask image based on the detected target region; and generate the second image based on the target region mask image and the first image, where pixel values of a target region in the second image are all specified pixel values, and pixel values of a non-target region in the second image are consistent with pixel values of a non-target region in the first image.

The image processing apparatus according to the embodiment of the present disclosure may perform the image processing method according to any embodiment of the present disclosure, and has corresponding functional modules and beneficial effects for performing the method.

It may be clearly understood by those skilled in the art that, for convenience and brevity of description, for the specific operation processes of the apparatus embodiment described above, reference may be made to the corresponding processes in the method embodiments, and details are not described herein again.

An embodiment of the present disclosure further provides an electronic device. The electronic device includes: a processor; and a memory configured to store instructions executable by the processor, where the processor is configured to read the executable instructions from the memory, and execute the instructions to implement the abovementioned image processing method.

FIG. 6 is a schematic structural diagram of an electronic device according to an embodiment of the present disclosure. As shown in FIG. 6, the electronic device 600 includes one or more processors 601 and a memory 602.

The processor 601 may be a central processing unit (CPU) or another form of processing unit having data processing capabilities and/or instruction execution capabilities, and may control other components in the electronic device 600 to perform desired functions.

The memory 602 may include one or more computer program products, which may include various forms of computer-readable storage media, such as a volatile memory and/or a non-volatile memory. The volatile memory may include, for example, a random-access memory (RAM), and/or a cache memory (cache), etc. The non-volatile memory may include, for example, a read-only memory (ROM), a hard disk, a flash memory, etc. One or more computer program instructions may be stored on the computer-readable storage medium, and the processor 601 may execute the program instructions to implement the image processing method in the embodiments of the present disclosure described above and/or other desired functions. Various contents such as an input signal, a signal component, a noise component, etc. may also be stored in the computer-readable storage medium.

In an example, the electronic device 600 may further include: an input apparatus 603 and an output apparatus 604. These components are interconnected via a bus system and/or another form of connection mechanism (not shown).

In addition, the input apparatus 603 may further include, for example, a keyboard, a mouse, etc.

The output apparatus 604 may output various information to the outside, including determined distance information, direction information, etc. The output apparatus 604 may include, for example, a display, a speaker, a printer, a communications network and a remote output device connected thereto, etc.

Certainly, for simplicity, only some of the components in the electronic device 600 related to the present disclosure are shown in FIG. 6, and components such as buses, input/output interfaces, etc. are omitted. In addition, the electronic device 600 may further include any other appropriate components according to the specific applications.

In addition to the abovementioned method and device, an embodiment of the present disclosure may further be a computer program product including computer program instructions that, when executed by a processor, cause the processor to perform the image processing method provided in the embodiment of the present disclosure.

In the computer program product, program code for performing the operations of the embodiments of the present disclosure may be written in any combination of one or more programming languages, where the programming languages include an object-oriented programming language, such as Java, and C++, and further include conventional procedural programming languages, such as “C” language or similar programming languages. The program code may be completely executed on a user computing device, partially executed on a user device, executed as an independent software package, executed partially on a user computing device and partially on a remote computing device, or completely executed on a remote computing device or a server.

In addition, an embodiment of the present disclosure may further be a computer-readable storage medium, having computer program instructions stored thereon. The computer program instructions, when executed by a processor, cause the processor to perform the image processing method according to the embodiments of the present disclosure.

The computer-readable storage medium may be any combination of one or more readable media. The readable medium may be a readable signal medium or a readable storage medium. The readable storage medium may include, for example, but not limited to, an electronic, magnetic, optical, electromagnetic, infrared, or semiconductor system, apparatus, or device, or any combination thereof. More specific examples of the readable storage media (a non-exhaustive list) include: an electrical connection having one or more wires, a portable disk, a hard disk, a random-access memory (RAM), a read-only memory (ROM), an erasable programmable read-only memory (EPROM or flash), an optic fiber, a portable compact disk read-only memory (CD-ROM), an optical storage device, a magnetic storage device, or any suitable combination thereof.

An embodiment of the present disclosure further provides a computer program product, including a computer program/instruction that, when executed by a processor, implements the image processing method in the embodiments of the present disclosure.

It may be understood that before the use of the technical solutions disclosed in the embodiments of the present disclosure, the user shall be informed of the type, range of use, use scenarios, etc. of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It may be understood that the abovementioned process of notifying and obtaining user authorization is only illustrative and does not constitute a limitation on the implementations of the present disclosure, and other manners that satisfy the relevant laws and regulations may also be applied in the implementations of the present disclosure.

It should be noted that the relational terms such as “first” and “second” herein are only used to distinguish one entity or operation from another, and do not necessarily require or imply that any actual relationship or sequence exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments described herein, but extends to the widest scope that complies with the principles and novelty disclosed in this specification.

1. An image processing method, comprising:
obtaining a first image;
detecting a target region in the first image, and masking the detected target region to obtain a second image; and
performing retouching based on the second image to obtain a target image, wherein there is a difference between a target region in the target image and the target region in the first image.

2. The method according to claim 1, wherein the performing retouching based on the second image to obtain a target image comprises:
detecting a specified sub-region in the target region in the first image to obtain a sub-region detection result; and
performing retouching based on the sub-region detection result and the second image to obtain the target image.

3. The method according to claim 2, wherein a specified sub-region in the target image matches the specified sub-region in the first image.

4. The method according to claim 2, wherein the sub-region detection result is presented in the form of a specified sub-region mask image, and the performing retouching based on the sub-region detection result and the second image comprises:
inputting the specified sub-region mask image and the second image into a preset neural network model, so that the neural network model retouches a target region in the second image based on the sub-region detection result.

5. The method according to claim 4, wherein the neural network model is obtained through the following steps:
obtaining a first sample image;
detecting a target region in the first sample image, and masking the detected target region to obtain a second sample image;
obtaining a specified sub-region mask image corresponding to the first sample image, and inputting the second sample image and the specified sub-region mask image corresponding to the first sample image into an initial neural network model to obtain a generated image output by the initial neural network model; and
adjusting parameters of the initial neural network model based on the generated image, the first sample image and a preset loss function until a neural network model meeting a preset condition is obtained.

6. The method according to claim 5, wherein a degree of beauty of the target region in the first sample image is greater than a preset degree threshold.

7. The method according to claim 5, wherein the adjusting parameters of the initial neural network model based on the generated image, the first sample image and a preset loss function comprises:
obtaining an adversarial loss value between the generated image and the first sample image based on a preset adversarial loss function;
obtaining a pixel loss value between the generated image and the first sample image based on a preset pixel loss function; and
adjusting the parameters of the initial neural network model based on the adversarial loss value and the pixel loss value.

8. The method according to claim 1, wherein the masking the detected target region to obtain a second image comprises:
generating a target region mask image based on the detected target region; and
generating the second image based on the target region mask image and the first image, wherein pixel values of a target region in the second image are all specified pixel values, and pixel values of a non-target region in the second image are consistent with pixel values of a non-target region in the first image.

9. (canceled)

10. An electronic device, comprising:
a processor; and
a memory configured to store instructions executable by the processor, wherein
the processor is configured to read the executable instructions from the memory, and execute the instructions to:
obtain a first image;
detect a target region in the first image, and mask the detected target region to obtain a second image; and
perform retouching based on the second image to obtain a target image, wherein there is a difference between a target region in the target image and the target region in the first image.

11. A non-transitory computer-readable storage medium having a computer program stored thereon, wherein the computer program is configured to:
obtain a first image;
detect a target region in the first image, and mask the detected target region to obtain a second image; and
perform retouching based on the second image to obtain a target image, wherein there is a difference between a target region in the target image and the target region in the first image.

12. The electronic device according to claim 10, wherein the instructions to perform retouching based on the second image to obtain a target image comprise instructions to:
detect a specified sub-region in the target region in the first image to obtain a sub-region detection result; and
perform retouching based on the sub-region detection result and the second image to obtain the target image.

13. The electronic device according to claim 12, wherein a specified sub-region in the target image matches the specified sub-region in the first image.

14. The electronic device according to claim 12, wherein the sub-region detection result is presented in the form of a specified sub-region mask image, and the instructions to perform retouching based on the second image to obtain a target image comprise instructions to:
input the specified sub-region mask image and the second image into a preset neural network model, so that the neural network model retouches a target region in the second image based on the sub-region detection result.

15. The electronic device according to claim 14, wherein the neural network model is obtained through the following steps:
obtaining a first sample image;
detecting a target region in the first sample image, and masking the detected target region to obtain a second sample image;
obtaining a specified sub-region mask image corresponding to the first sample image, and inputting the second sample image and the specified sub-region mask image corresponding to the first sample image into an initial neural network model to obtain a generated image output by the initial neural network model; and
adjusting parameters of the initial neural network model based on the generated image, the first sample image and a preset loss function until a neural network model meeting a preset condition is obtained.

16. The electronic device according to claim 15, wherein a degree of beauty of the target region in the first sample image is greater than a preset degree threshold.

17. The electronic device according to claim 15, wherein the adjusting parameters of the initial neural network model based on the generated image, the first sample image and a preset loss function comprises:
obtaining an adversarial loss value between the generated image and the first sample image based on a preset adversarial loss function;
obtaining a pixel loss value between the generated image and the first sample image based on a preset pixel loss function; and
adjusting the parameters of the initial neural network model based on the adversarial loss value and the pixel loss value.

18. The electronic device according to claim 10, wherein the instructions to mask the detected target region to obtain a second image comprise instruction to:
generate a target region mask image based on the detected target region; and
generate the second image based on the target region mask image and the first image, wherein pixel values of a target region in the second image are all specified pixel values, and pixel values of a non-target region in the second image are consistent with pixel values of a non-target region in the first image.

19. The non-transitory computer-readable storage according to claim 11, wherein the computer program being configured to perform retouching based on the second image to obtain a target image is further configured to:
detect a specified sub-region in the target region in the first image to obtain a sub-region detection result; and
perform retouching based on the sub-region detection result and the second image to obtain the target image.

20. The non-transitory computer-readable storage according to claim 19, wherein a specified sub-region in the target image matches the specified sub-region in the first image.

21. The non-transitory computer-readable storage according to claim 19, wherein the sub-region detection result is presented in the form of a specified sub-region mask image, and the computer program being configured to perform retouching based on the second image to obtain a target image is further configured to:
input the specified sub-region mask image and the second image into a preset neural network model, so that the neural network model retouches a target region in the second image based on the sub-region detection result.
